(19) United States
(12) Patent Application Publication
(10) Pub. No.: US 2015/0197998 A1
(43) Pub. Date: Jul. 16, 2015

(54) PROCESS FOR RECOVERY OF OLEAGINOUS FLUIDS FROM WELLBORE FLUIDS

(71) Applicant: M-I, L.L.C., houston, TX (US)

(72) Inventors: Mukesh Kapila, The Woodlands, TX (US); Matthew Offenbacher, Houston, TX (US)

(21) Appl. No.: 14/414,084

(22) PCT Filed: Jul. 8, 2013
(86) PCT No.: PCT/US2013/049570

§ 371 Date: Jan. 9, 2015

Related U.S. Application Data
(60) Provisional application No. 61/669,512, filed on Jul. 9, 2012.

(51) Int. Cl. E21B 21/01; B01D 21/01; B01D 17/02

(52) U.S. Cl. CPC E21B 21/01; B01D 17/0202; B01D 21/01; B01D 17/0214

(57) ABSTRACT

A process for treating a wellbore is disclosed. The process may include mixing at least one of a surfactant or an emulsifier with the spent wellbore fluid comprising an oleaginous fluid and a silica viscosifying agent.

### BACKGROUND

When drilling and completing wells in earth formations, various fluids generally are used in the well for a variety of reasons. Common uses for wellbore fluids include: lubrication and cooling of drill bit cutting surfaces during general drilling operations or drilling in a targeted petroliferous formation, suspending dislodged formation pieces and transporting them to the surface, controlling formation fluid pressure to prevent blowouts, maintaining well stability and minimizing fluid loss into the formation through which the well is being drilled, fracturing the formation in the vicinity of the well, displacing the fluid within the well with another fluid, cleaning the well, testing the well, transmitting hydraulic horsepower to the drill bit, emplacing a packer, abandoning the well or preparing the well for abandonment, and otherwise treating the well or the formation.

Wellbore fluids or muds may include a base fluid, which is commonly water, diesel or mineral oil, or a synthetic compound. Weighting agents (most frequently barium sulfate or barite is used) may be added to increase density, and clays such as bentonite may be added to help remove cuttings from the well and to form a filtercake on the walls of the hole.

Wellbore fluids also contribute to the stability of the well bore, and control the flow of gas, oil or water from the pores of the formation in order to prevent, for example, the flow, or in undesired cases, the blow out of formation fluids or the collapse of pressured earth formations. The column of fluid in the hole exerts a hydrostatic pressure proportional to the depth of the hole and the density of the fluid. High-pressure formations may require a fluid with a density as high as about 10 pounds per gallon (ppg) and in some instances may be as high as 21 or 22 ppg.

Oil-based muds (OBMs) have been used because of their flexibility in meeting density, inhibition, friction reduction and rheological properties desired in wellbore fluids. The drilling industry has used water-based muds (WBMs) because they are inexpensive. The used mud and cuttings from wells drilled with WBMs can be readily disposed of onsite at most onshore locations. WBMs and cuttings can also be discharged from platforms in many U.S. offshore waters, as long as they meet current effluent limitations guidelines, discharge standards, and other permit limits.

### SUMMARY

The various components used in formulating wellbore fluids are generally selected to result in a stable mixture including suspended solids. Thus, deconstruction of the fluid to recover various components for re-use or recovery of the oil or other hydrocarbons from such wellbore fluids is often difficult. It has been found that addition of a surfactant or emulsifier to a wellbore fluid including an oleaginous base fluid and a silica viscosifying agent may enhance the separability of the components and recovery of the base fluid. The enhanced separability may thus allow reuse of the oleaginous base fluid.

In one aspect, embodiments disclosed herein may provide a process for treating a wellbore fluid. The process may include mixing at least one of a surfactant or an emulsifier with the spent wellbore fluid comprising an oleaginous fluid and a silica viscosifying agent.

In another aspect, embodiments disclosed herein may provide a method for treating a wellbore fluid. The method may include: mixing a water absorbing agent with the wellbore fluid to absorb any water present in the wellbore fluid comprising an oleaginous fluid and a silica viscosifying agent; separating the water absorbing agent from the wellbore fluid; mixing at least one of a surfactant or an emulsifier with the wellbore fluid; mixing an oil-based flocculent with the wellbore fluid to flocculate solid particles in the wellbore fluid; and separating the flocculated solids from the oleaginous fluid.

In another aspect, embodiments disclosed herein may provide a process of performing wellbore operations. The process may include: pumping a wellbore fluid comprising an oleaginous fluid and a silica viscosifying agent into a wellbore; recovering a spent wellbore fluid from the wellbore; mixing the spent wellbore fluid with at least one of a surfactant and an emulsifier; and separating the oleaginous fluid from the silica viscosifying agent.

This summary is provided to introduce a selection of concepts that are further described below in the detailed description. This summary is not intended to identify key or essential features of the claimed subject matter, nor is it intended to be used as an aid in limiting the scope of the claimed subject matter. Other aspects and advantages of the invention will be apparent from the following description and the appended claims.

### BRIEF DESCRIPTION OF DRAWINGS

FIG. 1 is a simplified process flow diagram of a process for recovering oleaginous fluid according to embodiments herein.

FIG. 2 is a simplified process flow diagram of a process for recovering oleaginous fluid according to embodiments herein.

FIG. 3 is a simplified process flow diagram of a wellbore operation according to embodiments herein.

### DETAILED DESCRIPTION

Embodiments disclosed herein relate to recovery of oil and other components of wellbore fluids used during various drilling and completion operations. Particularly, embodiments of the present disclosure relate to recovery of oil from wellbore fluids including an oil-containing base fluid and a silica viscosifying agent.

In addition to a base oil, wellbore fluids may contain various components or additives, such as weighting agents, viscosifying agents, fluid loss control additives, alkalinity control agents, water absorbing agents, wetting agents, and suspension aids. The various additives are generally selected to result used in the wellbore fluids being a stable mixture including suspended solids. Stable fluids, for example, will maintain their overall composition for an extended period of time, without separation of the various phases (direct or invert emulsions) or without separation of a top oil layer, such as for an all-oil based wellbore fluid.

The wellbore fluid, once formulated, is pumped downhole into a well for its intended purpose (drilling mud/drilled solids removal, cleanout fluid, packer fluid, breaker fluid, gravel packing, completion, etc.), and circulated back to the surface where it is recovered for treatment, separations, recovery, disposal, re-circulation, etc.

For example, a wellbore fluid, such as a drilling mud, may be circulated downhole to lift drilled solids out of the wellbore. At the surface, a portion of the drilled solids may be separated from the wellbore fluid and the wellbore fluid recirculated for continued use downhole. As the entirety of the drilled solids cannot be removed from the recovered wellbore fluid without also separating some of the desired additives (weighting agents, etc.), drilled solids may accumulate within the circulating wellbore fluid. The accumulation of solids may continue to a degree, after which point the fluid may lose stability or the properties of the fluid (density, viscosity, etc.) may change enough that the wellbore fluid needs to be replaced. The spent or used wellbore fluid may then be treated according to embodiments herein to separate and recover various additives and to separate and recover the base oil for recycle or reuse.

It has been found that addition of a surfactant or emulsifier to a spent wellbore fluid including an oleaginous base fluid and a silica viscosifying agent may enhance the separability of the components and recovery of the base fluid. The enhanced separability may thus allow reuse of the oleaginous base fluid.

Oil-Containing Wellbore Fluids

As mentioned above, the wellbore fluids herein may be oil-containing. The oil-containing wellbore fluid may contain an amount of an oleaginous fluid. In some embodiments, the oil-containing fluids may include an oleaginous fluid as the continuous phase of the fluid, whereas other embodiments may use a direct emulsion where the oleaginous fluid is a discontinuous phase within an aqueous or non-oleaginous continuous phase.

Oleaginous fluids may be a liquid, such as a natural or synthetic oil and in some embodiments, the oleaginous fluid may be selected from the group including diesel oil; mineral oil; a synthetic oil, such as hydrogenated and unhydrogenated olefins including polyalpha olefins, linear and branch olefins and the like, polydiorganosiloxanes, siloxanes, or organosiloxanes, esters of fatty acids, specifically straight chain, branched and cyclical alkyl ethers of fatty acids, mixtures thereof and similar compounds known to one of skill in the art; and mixtures thereof. In a particular embodiment, the fluids may be formulated using diesel oil or a synthetic oil as the external, continuous phase.

The fluid phase of the oil-containing wellbore fluid may be formed solely or substantially entirely of an oleaginous liquid, substantially free of an aqueous component and substantially free of emulsifiers or the like. In another embodiment, the fluid phase of the wellbore fluid is formed of an oleaginous liquid, substantially free of an aqueous component and substantially free of emulsifiers, but may contain some volume of a non-aqueous, non-oleaginous fluid. In yet another embodiment, the oil-containing wellbore fluid may be a direct emulsion where an oleaginous fluid is a discontinuous phase within an aqueous or non-oleaginous continuous phase formulated to be substantially free of emulsifiers or the like.

In some embodiments, the oleaginous fluid may be present without any aqueous or non-oleaginous phase or may be substantially free of an aqueous and/or non-oleaginous fluid (such as those discussed below). As used herein, substantially free of an aqueous or non-oleaginous fluid may be interpreted to mean that the fluid contains less than 20 vol % of an aqueous or non-oleaginous fluid, or less than 10 vol % or 5 vol % in other embodiments.

In some embodiments, the wellbore fluid may be considered an “all-oil” based wellbore fluid. As used herein, “all-oil” refers to the fluid being essentially free of free water. For example, embodiments herein may include a water-absorbing agents, such as a polyacrylate, to pull residual, entrained, or produced water out of the fluid, binding the water so as to limit the water's ability to interact with the other additives in the wellbore formulation, and minimizing or negating any effect the water may have on the desired properties of the fluid.

However, in other embodiments, the fluid may contain a non-aqueous, non-oleaginous fluid having partial miscibility (i.e., some but not total solubility, such as at least 10-25% or greater miscibility) with the oleaginous fluid in an amount that is in excess of 20 vol %. Additionally, mutual solvents, i.e., a fluid having solubility in both aqueous and oleaginous fluids, may be present in the oleaginous fluid, including in the oleaginous fluids that are at least substantially free of an aqueous or non-oleaginous fluid. Illustrative examples of such mutual solvents include for example, isopropanol, diethylene glycol monoethyl ether, dipropylene glycol monomethyl ether, tripropylene butyl ether, dipropylene glycol butyl ether, diethylene glycol butyl ether, butylcarbitol, dipropylene glycol methylether, various esters, such as ethyl lactate, propylene carbonate, butylene carbonate, etc, and pyrolidones.

When formulated without or substantially free of an aqueous or non-oleaginous phase (or even if containing a non-aqueous, non-oleaginous fluid with partial miscibility with an oleaginous fluid), the fluid may also be free or substantially free of any unassociated surfactants, wetting agents, or emulsifiers, i.e., any amphiphilic compounds possessing both hydrophilic and hydrophobic groups within the molecule. As used herein, “unassociated” refers to molecules that are not chemically bound to or otherwise chemically or physically associated with another species (such as a solid weighting agent). Under such definition, a dispersant or wetting agent that is provided as a coating on weighting agent would be considered to be associated, not unassociated. As used herein, substantially free of an unassociated surfactant, wetting agent, or emulsifier means less than an amount that would generate an invert emulsion for any amount of an aqueous or non-oleaginous fluid present in the fluid. Such amounts may, for example, be less than 5 pounds per barrel (ppb) or less than 4 ppb, 3 ppb, 2 ppb, or 1 ppb, in other embodiments. Thus, a wetting agent or dispersant may be provided to coat a solid weighting agent, but the amount added would not be so much that an invert emulsion could be formed with any excess wetting agent or dispersant. Such excess may be less than 5 ppb, 4 ppb, 3 ppb, 2 ppb, or 1 ppb, in various embodiments.

In some embodiments, the wellbore fluid may be a direct emulsion having an aqueous or non-oleaginous fluid as a continuous phase, where the oleaginous fluid is provided as a discontinuous phase provided therein. Direct emulsions may be formulated to be substantially free of an emulsifier, surfactant, dispersant, or wetting agent, as defined above. Non-oleaginous fluids that may be used in the embodiments disclosed herein may be a liquid, such as an aqueous liquid. In embodiments, the non-oleaginous liquid may be selected from the group including fresh water, sea water, a brine containing organic and/or inorganic dissolved salts, liquids containing water-miscible organic compounds and combinations thereof. For example, the aqueous fluid may be formulated with mixtures of desired salts in fresh water. Such salts may include, but are not limited to alkali metal chlorides, hydroxides, or carboxylates, for example. In various embodiments of the wellbore fluid disclosed herein, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium, salts of chlorides, bromides, carbonates, iodides, chlorates, bromates, formates, nitrates, oxides, phosphates, sulfates, silicates, and fluorides. Salts that may be incorporated in a given brine include any one or more of those present in natural seawater or any other organic or inorganic dissolved salts. Additionally, brines that may be used in the wellbore fluids disclosed herein may be natural or synthetic, with synthetic brines tending to be much simpler in constitution. In one embodiment, the density of the wellbore fluid may also be controlled by increasing the salt concentration in the brine (up to saturation). In a particular embodiment, a brine may include halide or carboxylate salts of mono- or divalent cations of metals, such as cesium, potassium, calcium, zinc, and/or sodium. Specific examples of such salts include, but are not limited to, NaCl, CaCl₂, NaBr, CaBr₂, ZnBr₂, NaHCO₂, KHCO₂, KCl, NH₄Cl, CsHCO₂, MgCl₂, MgBr₂, KH₃C₂O₂, KBr, NaH₃C₂O₂ and combinations thereof.

In the embodiments using direct emulsions, the wellbore fluid may contain an oleaginous fluid in an amount that has a lower limit of any of 10 vol %, 20 vol %, 30 vol %, 40 vol % or 50 vol %, and an upper limit of any of 40 vol %, 50 vol %, 60 vol %, 70 vol %, or 80 vol %, with any lower limit being combinable with any upper limit. In specific embodiments, the oleaginous fluid may form 20-70 vol % of the wellbore fluid, 30-60 vol %, or 40-50 vol %, with the balance of the fluidic portion being the non-oleaginous fluid.

Solid Weighting Agents

If necessary, the density of the fluid may be increased by incorporation of a solid weighting agent. Solid weighting agents used in some embodiments disclosed herein may include a variety of inorganic compounds well known to one of skill in the art. In some embodiments, the weighting agent may be selected from one or more of the materials including, for example, barium sulphate (barite), calcium carbonate (calcite or aragonite), dolomite, ilmenite, hematite or other iron ores, olivine, siderite, manganese oxide, and strontium sulphate. In a particular embodiment, calcium carbonate or another acid soluble solid weighting agent may be used. In other embodiments, the weighting agent may be a precipitated silica, as described below.

One having ordinary skill in the art would recognize that selection of a particular material may depend largely on the density of the material because generally the lowest wellbore fluid viscosity at any particular density is obtained by using the highest density particles. In some embodiments, the weighting agent may be formed of particles that are composed of a material of specific gravity of at least 2.3; at least 2.4 in other embodiments; at least 2.5 in other embodiments; at least 2.6 in other embodiments; and at least 2.68 in yet other embodiments. Higher density weighting agents may also be used with a specific gravity of about 4.2, 4.4 or even as high as 5.2. For example, a weighting agent formed of particles having a specific gravity of at least 2.68 may allow wellbore fluids to be formulated to meet most density requirements yet have a particulate volume fraction low enough for the fluid to be pumpable. However, other considerations may influence the choice of product such as cost, local availability, the power required for grinding, and whether the residual solids or filtercake may be readily removed from the well. In particular embodiments, the wellbore fluid may be formulated with calcium carbonate or another acid-soluble material.

The solid weighting agents may be of any particle size (and particle size distribution), but some embodiments may include weighting agents having a smaller particle size range than API grade weighing agents, which may generally be referred to as micronized weighting agents. Such weighting agents may generally be in the micron (or smaller) range, including submicron particles in the nanosized range.

In some embodiments, the average particle size (d50) of the weighting agents may range from a lower limit of greater than 5 nm, 10 nm, 30 nm, 50 nm, 100 nm, 200 nm, 500 nm, 700 nm, 0.5 micron, 1 micron, 1.2 microns, 1.5 microns, 3 microns, 5 microns, or 7.5 microns to an upper limit of less than 500 nm, 700 microns, 1 micron, 3 microns, 5 microns, 10 microns, 15 microns, 20 microns, where the particles may range from any lower limit to any upper limit. In other embodiments, the d90 (the size at which 90% of the particles are smaller) of the weighting agents may range from a lower limit of greater than 20 nm, 50 nm, 100 nm, 200 nm, 500 nm, 700 nm, 1 micron, 1.2 microns, 1.5 microns, 2 microns, 3 microns, 5 microns, 10 microns, or 15 microns to an upper limit of less than 30 microns, 25 microns, 20 microns, 15 microns, 10 microns, 8 microns, 5 microns, 2.5 microns, 1.5 microns, 1 micron, 700 nm, 500 nm, where the particles may range from any lower limit to any upper limit. The above described particle ranges may be achieved by grinding down the materials to the desired particle size or by precipitation of the material from a bottoms up assembly approach. Precipitation of such materials is described in U.S. Patent Application Publication No. 2010/009874, which is assigned to the present assignee and herein incorporated by reference. One of ordinary skill in the art would recognize that, depending on the sizing technique, the weighting agent may have a particle size distribution other than a monomodal distribution. That is, the weighting agent may have a particle size distribution that, in various embodiments, may be monomodal, which may or may not be Gaussian, bimodal, or polymodal.

In one embodiment, a weighting agent is sized such that: particles having a diameter less than 1 microns are 0 to 15 percent by volume; particles having a diameter between 1 microns and 4 microns are 15 to 40 percent by volume; particles having a diameter between 4 microns and 8 microns are 15 to 30 by volume; particles having a diameter between 8 microns and 12 microns are 5 to 15 percent by volume; particles having a diameter between 12 microns and 16 microns are 3 to 7 percent by volume; particles having a diameter between 16 microns and 20 microns are 0 to 10 percent by volume; particles having a diameter greater than 20 microns are 0 to 5 percent by volume. In another embodiment, the weighting agent is sized so that the cumulative volume distribution is: less than 10 percent or the particles are less than 1 microns; less than 25 percent are in the range of 1 microns to 3 microns; less than 50 percent are in the range of 2 microns to 6 microns; less than 75 percent are in the range of 6 microns to 10 microns; and less than 90 percent are in the range of 10 microns to 24 microns.

The use of weighting agents having such size distributions has been disclosed in U.S. Patent Application Publication Nos. 2005/0277553 and 2010/0009874, which are assigned to the assignee of the current application, and herein incorporated by reference. Particles having these size distributions may be obtained any means known in the art.

In some embodiments, the weighting agents include dispersed solid colloidal particles with a weight average particle diameter (d50) of less than 10 microns that are coated with an organophilic, polymeric deflocculating agent or dispersing agent. In other embodiments, the weighting agents include dispersed solid colloidal particles with a weight average particle diameter (d50) of less than 8 microns that are coated with a polymeric deflocculating agent or dispersing agent; less than 6 microns in other embodiments; less than 4 microns in other embodiments; and less than 2 microns in yet other embodiments. The fine particle size will generate suspensions or slurries that will show a reduced tendency to sediment or sag, and the polymeric dispersing agent on the surface of the particle may control the inter-particle interactions and thus will produce lower rheological profiles. It is the combination of fine particle size and control of colloidal interactions that reconciles the two objectives of lower viscosity and minimal sag.

In some embodiments, the weighting agents may be uncoated. In other embodiments, the weighting agents may be coated with an organophilic coating such as a dispersant, including carboxylic acids of molecular weight of at least 150 Daltons, such as oleic acid, stearic acid, and polybasic fatty acids, alkylbenzene sulphonic acids, alkane sulphonic acids, linear alpha-olefin sulphonic acid, and alkaline earth metal salts thereof. Further examples of suitable dispersants may include a polymeric compound, such as a polyacrylate ester composed of at least one monomer selected from stearyl methacrylate, butylacrylate and acrylic acid monomers. The illustrative polymeric dispersant may have an average molecular weight from about 10,000 Daltons to about 200,000 Daltons and in another embodiment from about 17,000 Daltons to about 30,000 Daltons. One skilled in the art would recognize that other acrylate or other unsaturated carboxylic acid monomers (or esters thereof) may be used to achieve substantially the same results as disclosed herein.

In embodiments, the coated weighting agents may be formed by either a dry coating process or a wet coating process. Weighting agents suitable for use in other embodiments disclosed herein may include those disclosed in U.S. Patent Application Publication Nos. 2004/0127366, 2005/0101493, 2006/0188651, 2008/0064613, and U.S. Pat. Nos. 6,586,372 and 7,176,165, each of which is hereby incorporated by reference.

The particulate materials as described herein (i.e., the coated and/or uncoated weighting agents) may be added to a wellbore fluid as a weighting agent in a dry form or concentrated as slurry in either an aqueous medium or as an organic liquid. As is known, an organic liquid may have the environmental characteristics required for additives to oil-containing wellbore fluids. With this in mind, the oleaginous fluid may have a kinematic viscosity of less than 10 centistokes (10 mm2/s) at 40° C. and, for safety reasons, a flash point of greater than 60° C., although not required for all applications. Suitable oleaginous liquids are, for example, diesel oil, mineral or white oils, n-alkanes or synthetic oils such as alpha-olefin oils, ester oils, mixtures of these fluids, as well as other similar fluids known to one of skill in the art of drilling or other wellbore fluid formulation. In one embodiment, the desired particle size distribution is achieved via wet milling of the coarser materials in the desired carrier fluid.

Such solid weighting agents may be particularly useful in wellbore fluids formulated with an entirely oleaginous fluid phase. In a particular embodiment, an organophilic coated weighting agent having a particle size within any of the described ranges may be used in a fluid free of or substantially free of an aqueous phase contained therein. Solid weighting agents may also be used in the direct emulsion emulsions of the present disclosure to provide additional density beyond that provided by the aqueous phase as needed.

In an embodiment, the wellbore fluid may have a density of greater than about 8.0 pounds per gallon (ppg), or at least 10, 12, or 14 ppg in other embodiment. In yet another embodiment the density of the wellbore fluid in some embodiments ranges from about 6 to about 18 ppg, where the weighting agent is added in an amount to increase the density of the base fluid by at least 1 ppg or by at least 2, 4, or 6 ppg in other embodiments.

Wellbore Fluid Additives

Other additives that may be included in the wellbore fluids disclosed herein include, for example, wetting agents, organophilic clays, viscosifiers, fluid loss control agents, surfactants, dispersants, interfacial tension reducers, pH buffers, mutual solvents, thinners, thinning agents, and cleaning agents. The addition of such agents should be well known to one of ordinary skill in the art of formulating wellbore fluids and muds.

In some embodiments, additives may be included in the composition to modify rheological properties, such as viscosity and flow. For example, organic thixotropes suitable for addition to wellbore fluids of the present disclosure include alkyl diamides, such as those having a general formula: R1-HN—O—(CH₂)ₙ—CO—NH—R2, wherein n is an integer from 1 to 20, from 1 to 4, or from 1 to 2, and R1 is an alkyl groups having from 1 to 20 carbons, from 4 to 12 carbons, or 5 to 8 carbons, and R2 is hydrogen or an alkyl group having from 1 to 20 carbons, or is hydrogen or an alkyl group having from 1 to 4 carbons, wherein R1 and R2 may or may not be identical. Such alkyl diamides may be obtained, for example, from M-I L.L.C. (Houston, Tex.) under the trade name of VERSAPAC™. Such alkyl diamide viscosifiers may be particularly suitable for use in an oil-containing wellbore fluid substantially free of an aqueous or non-oleaginous fluid, but may also be included in direct emulsions.

In other embodiments, organophilic clays, such as amine treated clays, may be useful as viscosifiers in the fluid composition of the present disclosure. TRUVIS, VG-SUPREME, VG69™ and VG-PLUS™ are organoclay materials, available from M-I L.L.C., Houston, Tex., that may be used in embodiments disclosed herein. Such organophilic clays, as well as water-based clays may be particularly useful in assisting in the formation and stabilization of a direct emulsion. Other viscosifiers that may be used include partially hydrolyzed polyacrylamide (PHPA), biopolymers (such as guar gum, starch, xanthan gum and the like), bentonite, attapulgite, sepiolite, polyamide resins, polyanionic carboxymethylcellulose (PAC or CMC), polyacrylates, lignosulfonates, as well as other water soluble polymers. When formulating a direct emulsion without an emulsifier, surfactant, etc., the viscosifier may be incorporated to increase the viscosity and thus miscibility of the two phases, such that a direct (oil-in-water) emulsion is formed upon mixing in a high shear mixer, as that term is understood by those of ordinary skill in the art, operating at at least 3500 rpm, or at least 5000 or 7000 rpm in other embodiments.

In other embodiments, precipitated silica may be used as a viscosifying agent. In yet other embodiments, precipitated silicas may advantageously be used to provide both weighting and viscosifying of the oleaginous base fluid. When used to provide weighting and visocifying, the precipitated silicas may be used in addition to or in place of the weighting agents described above. Alternatively, the relative amounts of the weighting agent and the precipitated silica in the wellbore fluid formulation may be adjusted such that the wellbore fluid has both the desired density and flow properties.

Precipitated silicas have a porous structure and may be prepared from the reaction of an alkaline silicate solution with a mineral acid. Alkaline silicates may be selected, for example, from one or more of sodium silicate, potassium silicate, lithium silicate and quaternary ammonium silicates. Precipitated silicas may be produced by the destabilization and precipitation of silica from soluble silicates by the addition of a mineral acid and/or acidic gases. The reactants thus include an alkali metal silicate and a mineral acid, such as sulfuric acid, or an acidulating agent, such as carbon dioxide. Precipitation may be carried out under alkaline conditions, for example, by the addition of a mineral acid and an alkaline silicate solution to water with constant agitation. The choice of agitation, duration of precipitation, the addition rate of reactants, temperature, concentration, and pH may vary the properties of the resulting silica particles.

Precipitated silicas useful in embodiments herein may include finely-divided particulate solid materials, such as powders, silts, or sands, as well as reinforced flocs or agglomerates of smaller particles of siliceous material. In some embodiments, the precipitated silica (or agglomerates thereof) may have an average particle size (D₅₀) of less than 100 microns; less than 50 microns in other embodiments; and in the range from about 1 micron to about 40 microns, such as about 25 to about 35 microns, in yet other embodiments. In some embodiments, precipitated silicas having a larger initial average particle size may be used, where shear or other conditions may result in comminution of the particles, such as breaking up of agglomerates, resulting in a silica particle having a useful average particle size.

Precipitated silicas may contain varying amounts of residual alkali metal salts that result from the association of the corresponding silicate counterion with available anions contributed by the acid source. Residual salts may have the basic formula MX, where M is a group 1 alkali metal selected from Li, Na, K, Cs, a group 2 metal selected from Mg, Ca, and Ba, or organic cations such as ammonium, tetraalkyl ammonium, imidazolium, alkyl imidazolium, and the like; and X is an anion selected from halides such as F, Cl, Br, I, and/or sulfates, sulfonates, phosphonates, perchlorates, borates, and nitrates. In an embodiment, the residual salts may be selected from one or more of Na₂SO₄ and NaCl, and the precipitated silica may have a residual salt content (equivalent Na2SO4) of less than about 2 wt. %. While the pH of the resulting precipitated silicas may vary, embodiments of the silicas useful in embodiments disclosed herein may have a pH in the range from about 6.5 to about 9, such as in the range from about 6.8 to about 8.

In other embodiments, surface-modified precipitated silicas may be used. The surface-modified precipitated silica may include a lipophilic coating, for example.

It has been found that surface-modified precipitated silicas according to embodiments herein may advantageously provide for both weighting and viscosifying of the oleaginous base fluid. Precipitated silicas according to embodiments herein are useful for providing wellbore fluids having enhanced thermal stability in temperature extremes, while exhibiting a substantially constant rheological profile over time.

In some embodiments, the surface of the silica particles may be chemically modified by a number of synthetic techniques. Surface functionality of the particles may be tailored to improve solubility, dispersibility, or introduce reactive functional groups. This may be achieved by reacting the precipitated silica particles with organosilanes or siloxanes, in which reactive silane groups present on the molecule may become covalently bound to the silica lattice that makes up the particles. Non-limiting examples of compounds that may be used to functionalize the surface of the precipitated silica particles include aminoalkylsilanes such as aminopropyltriethoxysilane, aminomethyltriethoxysilane, trimethoxy[3-(phenylamino)propyl]silane, and trimethyl[3-(triethoxysilyl)propyl]ammonium chloride; alkoxyorganomercapto silanes such as bis(3-(triethoxysilylpropyl)tetrasulfide, bis(3-(triethoxysilylpropyl)disulfide, vinyltrimethoxy silane, vinyltriethoxy silane, 3-mercaptopropyltrimethoxy silane; 3-mercaptopropyltriethoxy silane; 3-aminopropyltriethoxysilane and 3-aminopropyltrimethoxysilane; and alkoxysilanes.

In other embodiment, organo-silicon materials that contain reactive end groups may be covalently linked to the surface of the silica particles. Reactive polysiloxanes may include, for example, diethyl dichlorosilane, phenyl ethyl diethoxy silane, methyl phenyl dichlorosilane, 3,3,3-trifluoropropylmethyl dichlorosilane, trimethylbutoxy silane, sym-diphenyltetramethyl disiloxane, octamethyl trisiloxane, octamethyl cyclotetrasiloxane, hexamethyl disiloxane, pentamethyl dichlorosilane, trimethyl chlorosilane, trimethyl methoxysilane, trimethyl ethoxysilane, methyl trichlorosilane, methyl triethoxysilane, methyl trimethoxysilane, hexamethyl cyclotrisiloxane, hexamethyldisiloxane, hexaethyldisiloxane, dimethyl dichlorosilane, dimethyl dimethoxy silane, dimethyl diethoxysilane, polydimethylsiloxanes comprising 3 to 200 dimethylsiloxy units, trimethyl siloxy or hydroxydimethylsiloxy end blocked poly(dimethylsiloxane) polymers (silicone oils) having an apparent viscosity within the range of from 1 to 1000 mPascals at 25° C., vinyl silane, gamm-methacryloxypropyl trimethoxy silane, polysiloxanes, e.g., polysiloxane spheres, and mixtures of such organo-silicone materials.

The surface modification may be added to the silica after precipitation. Alternatively, the silica may be precipitated in the presence of one or more of the surface modification agents described above. The surface-modified precipitated silicas may have a BET-5 nitrogen surface area of less than about 200 m²/g. In some embodiments, the surface area of the surface-modified precipitated silica may be less than about 150 m²/g. In other embodiments, the surface area may be in the range from about 20 m²/g to about 70 m²/g.

In one or more embodiments, the precipitated silica has a BET-5 nirtogen surface area of 20 m²/g to 70 m²/g, as calculated from the surface adsorption of N₂ using the BET-1 point method, a pH in the range of pH 7.5 to pH 9, and an average particle diameter in the range of 20 nm to 100 nm.

In some embodiments, precipitated silicas useful in embodiments herein may include those as disclosed in U.S. Patent Application Publication Nos. 2010/0292386, 2008/0067468, 2005/0131107, 2005/0176852, 2006/0225615, 2006/0228632, and 2006/0281009, each of which is incorporated herein by reference.

Another additive to oleaginous wellbore fluids that may optionally be included in the oleaginous wellbore fluids disclosed herein is a fluid loss control agent. Fluid loss control agents may act to prevent the loss of fluid to the surrounding formation by reducing the permeability of the barrier of solidified wellbore fluid. Suitable fluid loss control agents may include those such as modified lignites, asphaltic compounds, gilsonite, organophilic humates prepared by reacting humic acid with amides or polyalkylene polyamines, and other fluid loss additives such as a methylstyrene/acrylate copolymer. Such fluid loss control agents may be employed in an amount which is at least from about 0.5 to about 15 pounds per barrel. The fluid-loss reducing agent should be tolerant to elevated temperatures, and inert or biodegradable. ECOTROL RD™, an oil-soluble polymeric fluid control agent that may be used in the wellbore fluid, is commercially available from M-I L.L.C., Houston, Tex.

Wellbore fluids according to embodiments disclosed herein may thus include an oleaginous base fluid and a silica viscosifying agent. As noted above, addition of a surfactant or emulsifier to a spent may enhance the separability of the components and recovery of the base fluid.

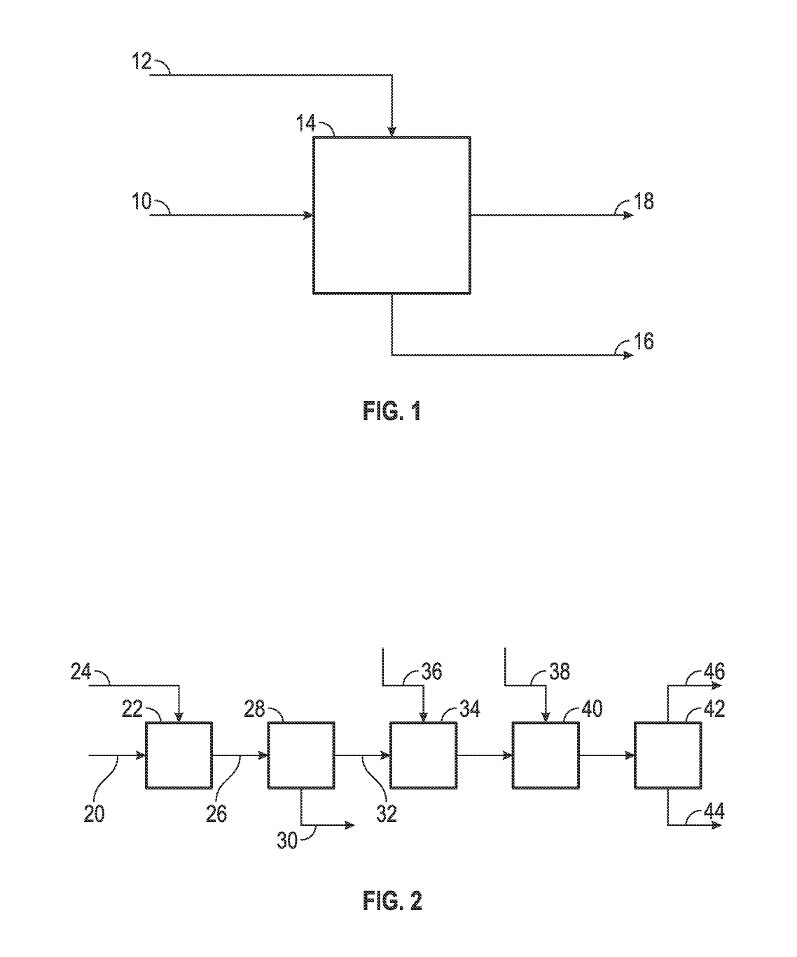

Referring now to FIG. 1, a simplified process flow diagram of a process for separating a base oil from a spent wellbore fluid is illustrated. A spent wellbore fluid, including an oleaginous base fluid and a silica viscosifying agent, and at least one of an emulsifier and a surfactant may be fed via flow lines 10 and 12, respectively, to a spent wellbore fluid treating unit 14. The surfactant or emulsifier may be, for example, a fatty acid derivative, dodecylbenzensulpholic acid, or combinations thereof.

In spent wellbore fluid treating unit 14, the wellbore fluid and the emulsifier and/or surfactant may be mixed, resulting in a decrease in the viscosity of the wellbore fluid. The reduced viscosity of the fluid may then be advantageously used to separate solid particles, such as the silica viscosifying/weighting agent, from the oleaginous base fluid.

The solid particles may be recovered via flow line 16 for further treatment or disposal. The oleaginous base fluid may be recovered via flow line 18. Following recovery, the oleaginous base fluid may be further treated, such as to remove additional components from the fluid, or may be recovered for recycle, reuse, or disposal. In some embodiments, for example, the oleaginous fluid may be recovered and reused in formulating another wellbore fluid for use in the same or a different well. Alternatively, the oleaginous fluid recovered, such as a diesel oil, may be sent to a production facility for inclusion with produced oil being sent to refiners or other end users.

Spent wellbore fluids, as described above, may include components in addition to the oleaginous base fluid and the silica viscosifying agent, such as weighting agents, drilled solids, clay, gravel packing materials, and fluid loss control agents, among others. Processes and wellbore fluid treating systems or units according to embodiments disclosed herein may thus include various additional process steps for separating and recovering the oleaginous fluid from a spent wellbore fluid.

For example, referring now to FIG. 2, a simplified process flow diagram of a process for separating an oleaginous fluid from a spent wellbore fluid is illustrated. One skilled in the art would appreciate that fewer than all of the process steps illustrated in FIG. 2 may be required for some wellbore fluid formulations, and additional steps over those illustrated may be required for other wellbore fluid formulations. Additionally, depending upon the particle size of the additives as well as the concentrations of the additives, base fluids, or dispersed phase fluids, among other factors, the various steps as illustrated in FIG. 2 may be performed in different orders so as to maximize recovery of the oleaginous fluid.

A wellbore fluid may be fed via flow line 20 to a dewatering system 22, for separating water from the wellbore fluid, where the water may be present as a continuous or dispersed phase, free water within the oleaginous phase, and may include produced water, added water, or water absorbed from the air by drilling mud in an open mud pit, for example. In dewatering system 22, the wellbore fluid may be contacted with a water absorbing agent fed via flow line 24. Water absorbing agents may include, in some embodiments, water absorbing polymers, such as polyacrylates, among others. Following contact, such as in a mixing tee, a holding tank, a pumparound system, or other fluid containment or transport devices or systems, the water absorbing agent may then absorb the water.

In addition to polyacrylates mentioned above, the swellable water absorbent media may include superabsorbent polymers (SAP) made from chemically modified starch and cellulose and other polymers like poly(vinyl alcohol) PVA, poly(ethylene oxide) PEO, all of which are hydrophilic and have a high affinity for water. When lightly cross-linked, chemically or physically, these polymers may be water swellable but not water-soluble. Also, SAPs are made from partially neutralised, lightly cross-linked poly(acrylic acid) may also be used. Cross-linking agents such as: tetraallylethoxy ethane or 1,1,1-trimethylolpropanetricrylate (TMPTA) may be used to provide the desired amount of crosslinking, for example.

After the water has been absorbed, the drilling fluid/water absorbent mixture may then be fed via flow line 26 to separation system 28 for separation of the water absorbent from the wellbore fluid. Separation system 28 may include a settling tank, a shaker, a centrifuge, or other various devices for separating solids of a particular size from fluids and/or solids of a different size. The water absorbing polymer 30 may then be recovered for treatment or disposal.

The dewatered drilling fluid may then be fed via flow line 32 to viscosity reduction system 34. In viscosity reduction system 34, the wellbore fluid may be mixed with an emulsifier and/or a surfactant, fed via flow line 36, resulting in a decrease in the viscosity of the wellbore fluid. The reduced viscosity of the fluid may then be advantageously used to separate solid particles, such as the silica weighting agent, from the oleaginous base fluid. Viscosity reduction system 34 may include a mixing tee, a holding tank, a pumparound system, or other fluid containment or transport devices or systems used for admixture of components.

After viscosity reduction, the wellbore fluid may be mixed with an oil-based flocculent 38 in flocculate system 40. Flocculate system 34 may include a mixing tee, a holding tank, a pumparound system, or other fluid containment or transport devices or systems used for admixture of components. The flocculant may then flocculate solid particles used in formulating the wellbore fluid. The flocculant selected should act on the solids in the wellbore fluid, promoting aggregation of solids in the fluid and increasing the efficiency of removal of the solids. Suitable flocculating agents may include polyacrylamides, quaternary amine polymers, and mixtures thereof, for example.

The solid particles may then be separated from the oleaginous fluid in separation system 42. Separation system 42 may include, for example, one or more of a settling tank, a centrifuge, a desilter, a desander, and a lamella separator, among others.

The separated solids 44 may then be recovered for further treatment or disposal. The oleaginous fluid may be recovered via flow line 46. Following recovery, the oleaginous fluid may be further treated, such as to remove additional components from the fluid, or may be recovered for recycle, reuse, or disposal. In some embodiments, for example, the oleaginous fluid may be recovered and reused in formulating another wellbore fluid for use in the same or a different well.

The processes as described above for FIGS. 1 and 2 may be performed batchwise, semi-batch, or in a continuous operation. Holding tanks, pumps and other process equipment may be used for one or more of the steps described above. For example, a holding tank may be used to both mix a flocculent and separate flocculated solids, for example. As another example, an agitated tank may be used to sequentially add the emulsifier or surfactant and the flocculent. Further, where settling tanks, shakers, or other separation devices are used to separate solids from liquids, when the operations are performed batchwise or semi-batch, various pieces of equipment may be used in two or more separation steps. For example, a shaker may be used to separate the water absorbing agent, and, following a screen change to a smaller mesh, flocculated solids may be separated using the same shaker. In this manner, the footprint of the oil recovery systems herein may be reduced.

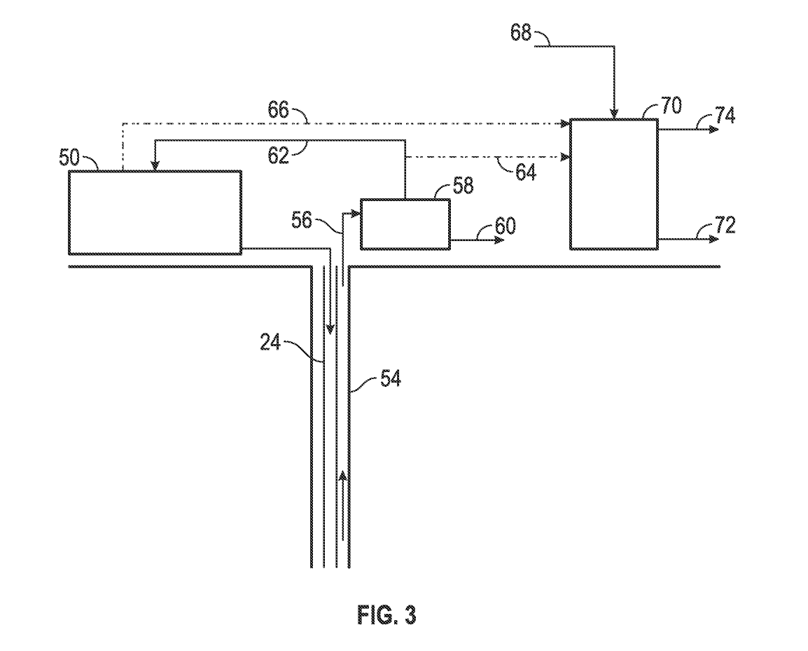

Referring now to FIG. 3, a simplified process flow diagram for a wellbore operation incorporating a spent wellbore fluid treatment system is illustrated. A wellbore fluid may be circulated from a mud tank 50, downhole, such as through the drill pipe 52, and may be recovered at the surface, such as from casing 54, via flow line 56. While described with respect to a cased hole, other circulation systems may also be used, including open-hole systems.

The wellbore fluid, which may be a drilling mud used during drilling operations, for example, may lift drilled solids out of the wellbore. The wellbore fluid, including drilled solids, may then be fed via flow line 56 to a shaker apparatus 58 for separation of drilled solids from the wellbore fluid. The separated drilled solids may be recovered via flow line 60. The wellbore fluid, having a reduced amount of drilled solids, may then be returned via flow line 62 to mud tank 50 for continued circulation through the wellbore.

As noted above, the entirety of the drilled solids may not be removed from the recovered wellbore fluid. Thus, over time, drilled solids may accumulate within the circulating wellbore fluid. The accumulation of solids may continue to a degree, after which point the fluid may lose stability or the properties of the fluid (density, viscosity, etc.) may change enough that the wellbore fluid needs to be replaced.

As needed, the wellbore fluid may be fed to a wellbore treatment system 70 for separation and recovery of the oleaginous fluid. For example, a purge stream 64 may be used to route wellbore fluid from the shaker. Alternatively or additionally, wellbore fluid may be fed to wellbore treatment system 70 directly from mud tank 50 via flow line 66.

In wellbore treatment system 70, the wellbore fluid may be mixed with an emulsifier and/or a surfactant, fed via flow line 68, resulting in a decrease in the viscosity of the wellbore fluid. The reduced viscosity of the fluid may then be advantageously used to separate solid particles, such as the silica weighting agent, from the oleaginous base fluid, as described above.

The solid particles may be recovered via flow line 72 for further treatment or disposal. In some embodiments, addition of the emulsifier or surfactant may result in breaking of the fluid into two or more phases. For example, the wellbore fluid may break into two phases, such as an oleaginous fluid phase and a solids phase, including the silica viscosifying agent and other solids materials present. In other embodiments, the wellbore fluid may break into three or more phases, such as an oleaginous fluid phase, a first solids phase including the silica viscosifying agent, and a second solids phase including a weighting agent, for example. In such embodiments, the solid phases may be recovered together or individually for further treatment, recycle, or disposal.

The oleaginous base fluid may be recovered via flow line 74. Following recovery, the oleaginous base fluid may be further treated, such as to remove additional components from the fluid, or may be recovered for recycle, reuse, or disposal. In some embodiments, for example, the oleaginous fluid may be recovered and reused in formulating another wellbore fluid for use in the same or a different well.

While FIG. 3 is described above with respect to drilling operations, wellbore treatment systems according to embodiments herein may similarly be used for recovery of oleaginous fluid from wellbore fluids used during other wellbore operations. While not illustrated or described at length, one skilled in the art may readily envision such embodiments based on the above description.

As used herein, a “well” includes at least one wellbore drilled into a subterranean formation, which may be a reservoir or adjacent to a reservoir. A wellbore may have vertical and horizontal portions, and it may be straight, curved, or branched. The wellbore may be an open-hole or cased-hole. In an open-hole wellbore, a tubing string, which allows fluids to be placed into or removed from the wellbore, is placed into the wellbore. In a cased-hole, a casing is placed into the wellbore, and a tubing string can be placed in the casing. An annulus is the space between two concentric objects, such as between the wellbore and casing, or between casing and tubing, where fluid can flow.

### EXAMPLES

Initially, single lab barrel mixes were made to optimize the concentration of viscosifier. A wellbore fluid was mixed by adding a silica viscosifier (MXR-084, a precipitated silica having a particle size D₅₀ of about 5.5 microns (available from PPG Industries, Pittsburgh, Pa.)) to a base oil and mixing at 60-80% load on an overhead mixer for 15 minutes. A micronized weighting agent (a micronized calcium carbonate weighting agent having a D₉₀ of about 10 microns, a D₅₀ of about 4 microns, and a D₁₀ of about 5 microns, coated with an organophilic coating made from stearyl methacrylate, butylacrylate and acrylic acid monomers) was added slowly to ensure thorough dispersion in the system. Rheology was then tested on a Fann 35 VG-Meter at 120° F. Shear did not play a noticeable role in viscosity. Table 1 shows the formulation mixed for a final density of 9.0 lb/gal. Six (6) lab barrel equivalents of fluid were mixed for the entire test sequence.

TABLE 1
Wellbore Fluid Formulation as Tested

| | | | |
|---|---|---|---|
| Diesel Oil | 0.866 | bbl/bbl | Base Fluid |
| Precipitated Silica Viscosifier | 12 | lb/bbl | Viscosifier |
| Micronized Weighting Agent | 110.5 | lb/bbl | Weighting Agent |

Rheology was tested for initial properties after mixing and also after 18 hours of static aging at 180° F. (Table 2). A modest drop in rheology was documented; however, there was no sign of weight material settling after static aging. Top oil separation was approximately 2 mm.

TABLE 2
Initial and Final Rheology

| Dial Reading/Property | 120° F. | 120° F. |
|---|---|---|
| 600 | 40 | 33 |
| 300 | 32 | 23 |
| 200 | 28 | 19 |
| 100 | 24 | 16 |
| 6 | 13 | 10 |
| 3 | 11 | 6 |
| Plastic Viscosity, cP | 8 | 10 |
| Yield Point, lb/100 ft2 | 24 | 13 |
| 10″ Gel, cP | 8 | 5 |

Disposal/Break Test

Fluid disposal directly impacts the economics of using the wellbore fluid. When used with a land rig which has access to a production facility, any recovered base fluid may be sent to production without issue or may be reused in another wellbore fluid; however, solids must be disposed of in another manner.

A break test was performed by treating a lab barrel of the wellbore fluid, as formulated in Table 1, with 4 lb/bbl of a fatty acid derivative surfactant. The viscosity appeared to break almost instantaneously. The drop in rheology is measured in Table 3.

TABLE 3
Rheology before and after treatment with 4 lb/bbl surfactant

| | Before | After |
|---|---|---|
| Dial Readinq/Property | 120° F. | 120° F. |
| 600 | 40 | 9 |
| 300 | 32 | 5 |
| 200 | 28 | 4 |
| 100 | 24 | 3 |
| 6 | 13 | 2 |
| 3 | 11 | 1 |
| Plastic Viscosity, cP | 8 | 5 |
| Yield Point, lb/100 ft2 | 24 | 1 |
| 10″ Gel, cP | 8 | — |

After less than 24 hours three phases were observed. The top layer was the diesel oil base fluid. A second, middle layer appeared to be the viscosifier. The bottom layer appeared to be a hard packing of weight material.

As described above, embodiments disclosed herein provide for the treatment of a wellbore fluid such that the oleaginous fluid contained therein may be recovered for recycle and reuse. Systems and processes herein may advantageously combine an emulsifier and/or a surfactant with a wellbore fluid to facilitate separation of the oleaginous fluid contained therein from viscosifying agents, such as a precipitated silica, and other wellbore fluid additives. Further, use of the precipitated silicas may be advantageous in applications where plugging of equipment may be a risk.

While the invention has been described with respect to a limited number of embodiments, those skilled in the art, having benefit of this disclosure, will appreciate that other embodiments may be devised which do not depart from the scope of the invention as disclosed herein. Accordingly, the scope of the invention should be limited only by the attached claims.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

1. A process for treating a wellbore fluid, the process comprising:
mixing at least one of a surfactant or an emulsifier with the wellbore fluid
comprising an oleaginous fluid and a silica viscosifying agent.

2. The process of claim 1, further comprising mixing an oil-based flocculent with the spent wellbore fluid.

3. The process of any of the above claims, further comprising mixing a water absorbing agent with the wellbore fluid to absorb any water from the spent wellbore fluid.

4. The process of claim 3, further comprising separating the water absorbing agent from the spent wellbore fluid.

5. The process of claim 1, further comprising separating the oleaginous fluid from the silica viscosifying agent.

6. A method for treating a wellbore fluid, the method comprising:
mixing a water absorbing agent with the wellbore fluid to absorb any water present in the wellbore fluid comprising an oleaginous fluid and a silica viscosifying agent;
separating the water absorbing agent from the wellbore fluid;
mixing at least one of a surfactant or an emulsifier with the wellbore fluid;
mixing an oil-based flocculent with the wellbore fluid to flocculate solid particles in the wellbore fluid; and
separating the flocculated solids from the oleaginous fluid.

7. The method of claim 6, further comprising reusing the oleaginous fluid in another wellbore fluid.

8. The method of claim 6, wherein the surfactant or the emulsifier comprises a fatty acid derivative, dodecylbenzensulpholic acid, or combinations thereof.

9. The method of claim 6, wherein the silica viscosifying agent comprises a precipitated silica.

10. The method of claim 9, wherein the wherein the surface-modified precipitated silica comprises a lipophilic coating.

11. A process of performing wellbore operations, the process comprising:
pumping a wellbore fluid comprising an oleaginous fluid and a silica viscosifying agent into a wellbore;
recovering a spent wellbore fluid from the wellbore;
mixing the spent wellbore fluid with at least one of a surfactant and an emulsifier; and
separating the oleaginous fluid from the silica viscosifying agent.

12. The process of claim 11, further comprising mixing an oil-based flocculent with the spent wellbore fluid.

13. The process of claim 11, further comprising mixing a water absorbing agent with the wellbore fluid to absorb any water from the spent wellbore fluid.

14. The process of claim 13, further comprising separating the water absorbing agent from the spent wellbore fluid.

15. The process of claim 13, further comprising reusing the oleaginous fluid in another wellbore fluid.

16. The process of claim 13, wherein the spent wellbore fluid further comprises at least one of a weighting agent, drilled solids, gravel packing materials, fluid loss control additives, and clay.

17. The process of claim 13, wherein the surfactant or emulsifier comprises a fatty acid derivative, dodecylbenzensulpholic acid, or combinations thereof.

18. The process of claim 13, wherein the silica viscosifying agent comprises a precipitated silica.

19. The process of claim 13, wherein the silica viscosifying agent comprises a surface-modified precipitated silica.

20. The process of claim 19, wherein the surface-modified precipitated silica comprises a lipophilic coating.
